(19) United States
(12) Patent Application Publication
(10) Pub. No.: US 2016/0224317 A1
(43) Pub. Date: Aug. 4, 2016

(54) AUDIBLE PHOTOS & VOICE COMMENTS IN DIGITAL SOCIAL INTERACTIONS

(71) Applicant: IAN SHERRARD THOMPSON, LANSDALE, PA (US)

(72) Inventors: IAN SHERRARD THOMPSON, LANSDALE, PA (US); WILLIAM THOMPSON, LANSDALE, PA (US); ADEEL ARIF, PHILADELPHIA, PA (US); NADINE ELIZABETH THOMPSON, LANSDALE, PA (US)

(21) Appl. No.: 14/996,397

(22) Filed: Jan. 15, 2016

Related U.S. Application Data
(60) Provisional application No. 62/110,536, filed on Jan. 31, 2015.

(51) Int. Cl. G06F 3/16; G06F 3/0482; G06F 3/0481

(52) U.S. Cl. CPC G06F 3/167; G06F 3/04817; G06F 3/0482

(57) ABSTRACT

Disclosed is a method and a system for creating an audible photo and for commenting on a social post. The method comprising the steps of listing out the control and possible ways for generating audio; bringing sound to the application on receiving access from the user; playing the audio file from an online resource; outlining the options for recording custom sound; tapping the speaker icon to listen to the attached audio; and displaying voice comments associated with the audio.

### CROSS REFERENCE TO RELATED PATENT APPLICATION

This non-provisional application takes priority from U.S. Provisional Application No. 62/110,536 filed on Jan. 31, 2015 and incorporates the entirety of same by reference herein.

### FIELD OF INVENTION

The present invention is directed to a system, method, and a software application related to voice-based interaction on a social network. More specifically, the invention relates to a user interface for attaching various subjects with audio/voice files on an electronic device.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In social networking, photo sharing is the most popular form of interaction. 350M photos are uploaded on Facebook daily, while Instagram has 300M active users uploading 70M photos daily. On existing social networks, the only way a user can interact with photos shared is by either “liking” it or using a textual comment.

Embodiments of the invention provide systems and methods for voice-based interaction on a social networking platform to facilitate a social or transactional exchange between two parties. It is an object of the present invention to provide a system and method and a software application to attach audio files to digital content such as photos shared on a digital platform. Additionally, embodiments of the invention enable users to interact with shared content using voice/audio files, introducing a new dimension to social interaction, allowing users to bring their emotions and sound to the engagement.

The present invention provides a graphical user interface to the user which enables him/her to attach their audio to the digital content shared and comment on it using pre-recorded sounds, audio file from the device, their own custom recording, or through a URL of a sound file available on the Internet.

The present invention provides a system, method and a software application that can be implemented on any electronic device and particularly, a smartphone, mobile phone, digital photo-frame, computer, laptop, radio, television, car navigation system, digital cameras, any tablet, other electronic entertainment devices and wireless communication devices, etc.

### BRIEF DESCRIPTION OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is a flowchart that describes a user interface for attaching a sound file to a photo and for leaving an audio comment on a social post.

FIG. 2 outlines the technical workflow for creating an Audible Photo and/or leaving an audio comment on a social post.

### DETAILED DESCRIPTION OF THE DRAWINGS

The following detailed description of the invention is merely exemplary in nature and is not intended to limit the invention or the application and uses of the invention. Furthermore, there is no intention to be bound by any theory presented in the preceding background of the invention or the following detailed description of the invention.

In one of the embodiments, the present invention allows user to attach an audio file to the photo. An audio file can be retrieved from the device, linked via URL, or recorded using the device's microphone. Once the audio file is ready, the user reviews and attaches it to the photo. Attaching of the audio file to the photo file is performed on the server such that the user can retrieve audio and photo files combined as one unit (referred to herein as an “Audible Photo” (AP)). The user can also extract photos independently if desired.

In one of the embodiments, a user can use pre-recorded sound clips available in the application library and select the clip they want to attach to the photo. Users can also add sound clips to the clip library. Additionally, the sound clips can be made available to other users of the network.

In another embodiment, pre-recorded clips can function as audio tags that can behave and function like hashtags in a social network. The system can aggregate photos based on the clip attached. Sound clip files can be updated dynamically based on system defined criteria. One criteria could be a trending pattern, where trending sound clips are available to be attached to the photo.

In yet another embodiment, users can comment on a photo using an audio file. An audio file can be retrieved from the device, linked via URL, or recorded using the device's microphone. Users can also reply to each other's comments using audio foes as well, hence creating a platform where they are interacting either solely using audio or in combination with textual comments. Interacting using voice allows users to bring emotions to their interaction in the way that textual interaction cannot.

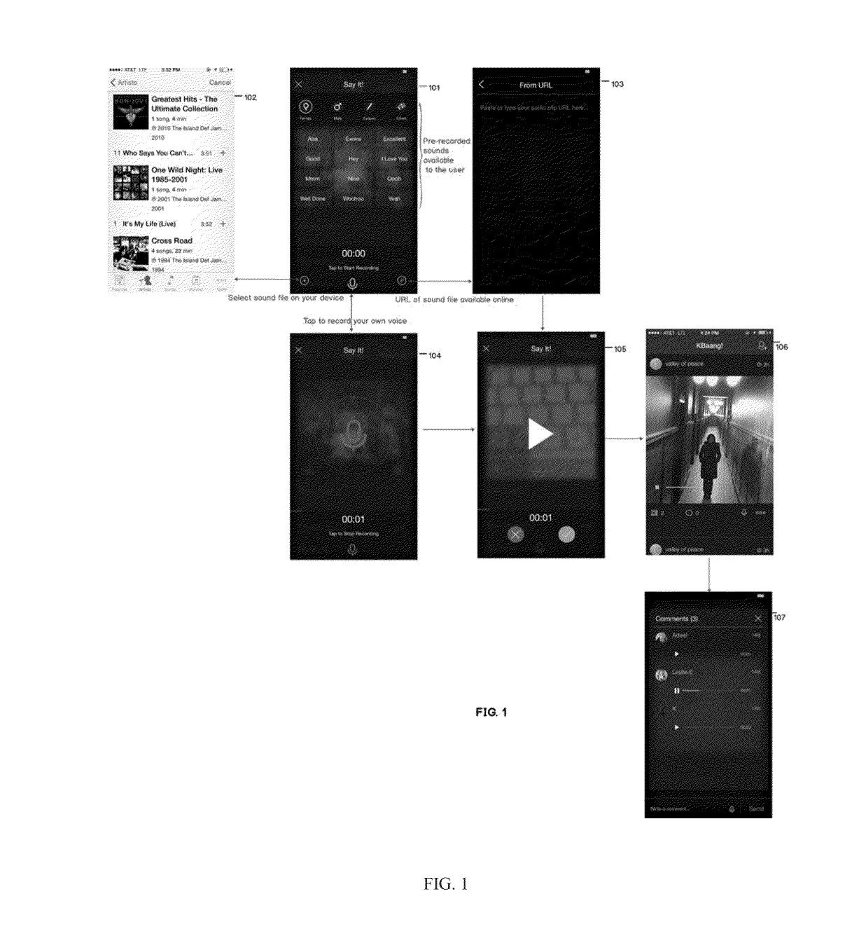

FIG. 1 outlines the user interface for creating an Audible Photo and for commenting on a social post using voice/audio. Step 101 shows one of the embodiments of the audio dashboard that lists out of the control and possible ways user can generate audio. Categories listed in the screen 101 are Male, Female, Cartoon, Others. Once user selects a category, the area below lists out all of the sounds available in that category.

The screen in the diagram shows female sounds available for a user to pick. In one of the embodiments, a user can add custom recorded sounds or select a sound clip from the device library to be added to the pre-recorded clips. In yet another embodiment, the user can create custom categories and save a sound clip to newly created categories. The user can also share the uploaded sound clip with other users.

Step 102 outlines the user accessing the audio file or music app on the user device to bring in sound to the application. Step 103 shows an embodiment where users can copy and paste the audio clip URL. System can either copy the audio file over the internal server or play directly from and online resource.

Step 104 outlines one of the options for recording custom sound. A user taps on the microphone icon to start recording and taps again on the microphone icon to stop recording. In step 105, the user taps the play button to review the audio file before attaching it to the server or posting it as an audio comment.

Step 106 outlines one of the embodiments for playing the audio file, wherein the user taps the speaker icon to listen to the attached audio. The user can also tap on the microphone icon to leave a voice/audio comment on the photo. Taping the microphone icon will open up the screen shown in step 101.

Step 107 displays one of the possible ways of displaying voice comments. The user taps on the play button to listen to the comment. The user can also tap on the microphone button shown at the bottom of the screen to leave a reply to a voice comment or add their own voice comment.

In one of the embodiments, the user can change the pitch, tone and/or speed of the sound using a voice synthesizer module. The user can also combine multiple sound clips and filters. The screen views shown in FIG. 1 are from an iPhone; however, the user device can be but not limited to a Smartphone, mobile phone, digital photo-frame, computer, laptop, radio, car navigation system, digital cameras, television, any tablet, and other electronic entertainment devices and wireless communication devices, etc.

In yet another embodiment of the invention, the user can attach an audio file to any form of digital content, such as a digital coupon, QR code, map, etc. The user can also use a combination of an audio file along with photo or digital content in other formats as listed above to facilitate a sale of product through the platform, while potential buyers can interact with seller using voice comments.

Voice Comments between seller and potential buyers can be set to private such that only seller can hear them, while other potential buyers do not see them in the feed. Additionally, the user can set the post/deal to expire at a specified time and upon reaching that time, the deal/sale is removed from potential buyers' deal feed. Time left to purchase is visible to all potential buyers while the deal is available in the feed.

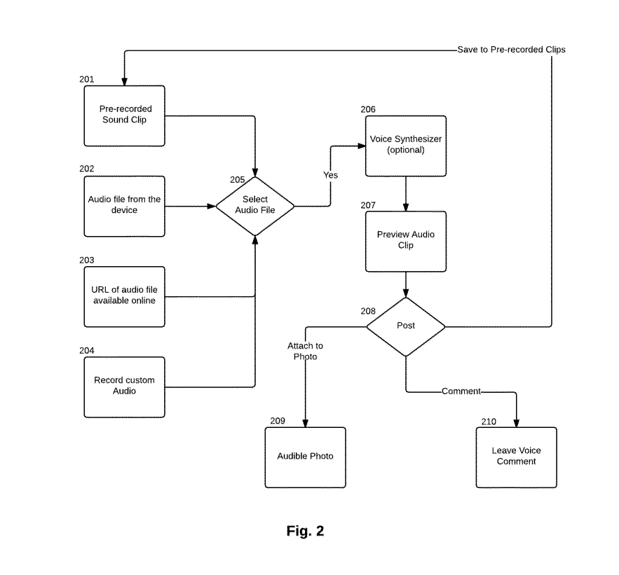

FIG. 2 outlines the workflow for creating an Audible Photo or for commenting on a social post using audio. At step 201, the user can select a pre-recorded sound clip. Sound clips can reside on the device or on the application server. At step 202, the user can select an audio file from the device or a song from a music app that saved on the user's device. At step 205, the user can paste a URL of a sound clip available online.

The system can copy the sound file over to the system's storage server or play directly from the online site using the URL. At step 204, the user can also record a custom sound using device's microphone. At step 205, the user can use one of the four options listed above to get the sound file. It is worth noting here that four options listed in FIG. 2 and explained above are just examples as there are several other options available to create or import sound file to the application.

Step 206 outlines an optional voice synthesizer that enables users to adjust the pitch, tone and speed of the recorded sound. The user can add background music and combine multiple audio files and apply sound filters to enhance and modify the audio file. At step 207, the user previews the audio file before posting it to the application. This step can also be made optional.

At step 208, the user can post the audio file either as an attachment to the photo to create audible photo or as comment to a social post. At step 209, the user can post the audio file as an attachment to a photo. At step 210, the user can post the audio file as a voice comment to a social post.

In one of the embodiments of the invention, the user can save the audio the to prerecorded sound cups in the application. The user can also share the audio clip with other users. The workflow described above for creating audible photo can be technically implemented in several different ways. Several examples of such implementations are as follows.

One option is to save audio files and photo files on a NoSQL media storage server generating location URL for both photo and audio files. The application takes the URLs of both files and saves them in an SQL database along with other metadata. The application displays photo and audio together by bringing the right combination of data and photo over to the client side using their respective URLs and displaying them on the screen using a specified template aligning audio and photo together.

In another embodiment of the invention, photo and audio files are combined and converted into mp4 format. An mp4 formatted media file is stored on the media storage sever while its URL is saved in the SQL database along with other metadata. In this implementation, audio and photo are combined and converted into a movie; however, to the user, it still appears and feels like a still photo with an audio attachment.

In one of the embodiments of the invention, the method of activating a voice comment can be performed with a simple voice command, where the system interprets the first word to be a system command to activate voice commenting. The user hears two distinctive beeps, alerting him or her that the system is ready for voice comment.

In yet another embodiment of the invention, a voice comment can be converted to a text string using Natural Language Processing techniques, giving the user's followers/friends the option to either hear or read the comment.

The software application of the present invention may be installed on the user device or accessed over a network. The system may employ any number of any conventional or other databases, data stores or storage structures (e.g., files, databases, data structures, data or other repositories, etc.) to store information (e.g. displayed data, voice tags).

The database system may be included within or coupled to the server and/or client systems or devices. The database systems and/or storage structures may be remote from or local to the device. Embodiments of the present invention may be utilized to attach audio to any type of digital object (e.g., single photo, multiple photos, QR code, Maps, Coupon.). Embodiments of the present invention may be employed with any suitable social media, e-commerce, or other environment.

The various embodiments of the present invention described herein are described in the general context of method steps or processes, which may be implemented in one embodiment by a computer program product, embodied in a computer-readable medium, including computer-executable instructions, such as program code, executed by computers in networked environments.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

Software and web implementations of various embodiments of the present invention can be accomplished with standard programming techniques with rule-based logic and other logic to accomplish various data linking and searching steps or processes, correlation steps or processes, comparison steps or processes and decision steps or processes.

The hand-held or mobile user devices which can be used to implement the present invention are preferably equipped with a display or monitor, a base (e.g., including at least one processor, one or more memories and/or internal or external network interfaces or communications devices (e.g., wireless, etc.)), optional input devices (e.g., a keyboard, touch screen, or other input device), and any commercially available and custom software (e.g., communications software, capture module, browser/interface software, applications, etc.).

The computer or other processing systems employed by the present invention embodiments may be implemented by any number of any personal or other type of computer or processing system (e.g., desktop, laptop, PDA, tablets or other mobile computing devices, etc.), and may include any commercially available operating system and any combination of commercially available and custom software (e.g., browser software, communications software, server software, tag module, capture module, social media environment module. etc.). The computer systems and devices may include any types of displays or monitors and input devices (e.g., keyboard, mouse, voice recognition, touch screen, etc.) to enter and/or view information.

It is to be understood that the software of the present invention embodiments may be implemented in any desired computer language and could be developed by one of ordinary skill in the computer arts based on the functional descriptions contained in the specification and flow chart illustrated in the drawings. The computer systems of the present invention embodiments may alternatively be implemented by any type of hardware and/or other processing circuitry.

The software and/or algorithms described above and illustrated in the flow charts may be modified in any manner that accomplishes the functions described herein. In addition, the functions in the flow charts or description may be performed in any order that accomplishes a desired operation.

While various embodiments have been described above, it should be understood that they have been presented by way of example only, and not limitation. For example, any of the elements may employ any of the desired functionality set forth hereinabove. Thus, the breadth and scope of a preferred embodiment should not be limited by any of the above-described exemplary embodiments, but should be defined only in accordance with the following claims and their equivalents.

1. A method for creating an audible photo and for commenting on a social post comprising the steps of:
listing out the control and possible ways for generating audio;
bringing sound to the application on receiving access from the user;
playing the audio the from an online resource;
outlining the options for recording custom sound;
tapping the speaker icon to listen to the attached audio; and
displaying voice comments associated with the audio.
